(19) United States
(12) Patent Application Publication
(10) Pub. No.: US 2012/0079767 A1
(43) Pub. Date: Apr. 5, 2012

(54) FUEL FROM SEPARATE HYDROGEN AND CARBON MONOXIDE FEEDS

(76) Inventors: Stephen Aplin, Ontario (CA); Donald S. Moore, Ontario (CA)

(21) Appl. No.: 13/264,364

(22) PCT Filed: Jul. 31, 2009
(86) PCT No.: PCT/IB2009/053349

§ 371 Date: Oct. 13, 2011

Related U.S. Application Data
(60) Provisional application No. 61/166,222, filed on Apr. 2, 2009.

(51) Int. Cl. C10J 3/46; B01J 10/00; C07C 1/04

(52) U.S. Cl. 48/197 R; 422/626; 518/704

(57) ABSTRACT

A process and system for producing synthesis gas (syngas) by combining hydrogen and carbon monoxide from separate sources while controlling the mole ratio (H2/CO) of the syngas product. Hydrogen is produced by splitting water. Carbon monoxide is produced by reacting carbon dioxide (CO2), which has been captured from the exhaust of stationary combustion engines, with hydrogen via the Reverse Water Gas Shift. Hydrocarbon fuels are produced from this syngas via the Fischer-Tropsch synthesis.

### TECHNICAL FIELD

This invention relates to the field of the production of synthetic hydrocarbon fuels and more specifically a system, method and process for producing synthesis gas from separate hydrogen and carbon monoxide feed.

### BACKGROUND ART

There are numerous methods of producing synthesis gas for fuel. However, the known processes require improvements to efficiency and fuel quality.

### DISCLOSURE OF INVENTION

The technical problem is the production of synthesis gas from separate hydrogen and carbon monoxide feed.

### DESCRIPTION OF DRAWINGS

FIG. 1 is a schematic of the system of the invention.

### BEST MODE

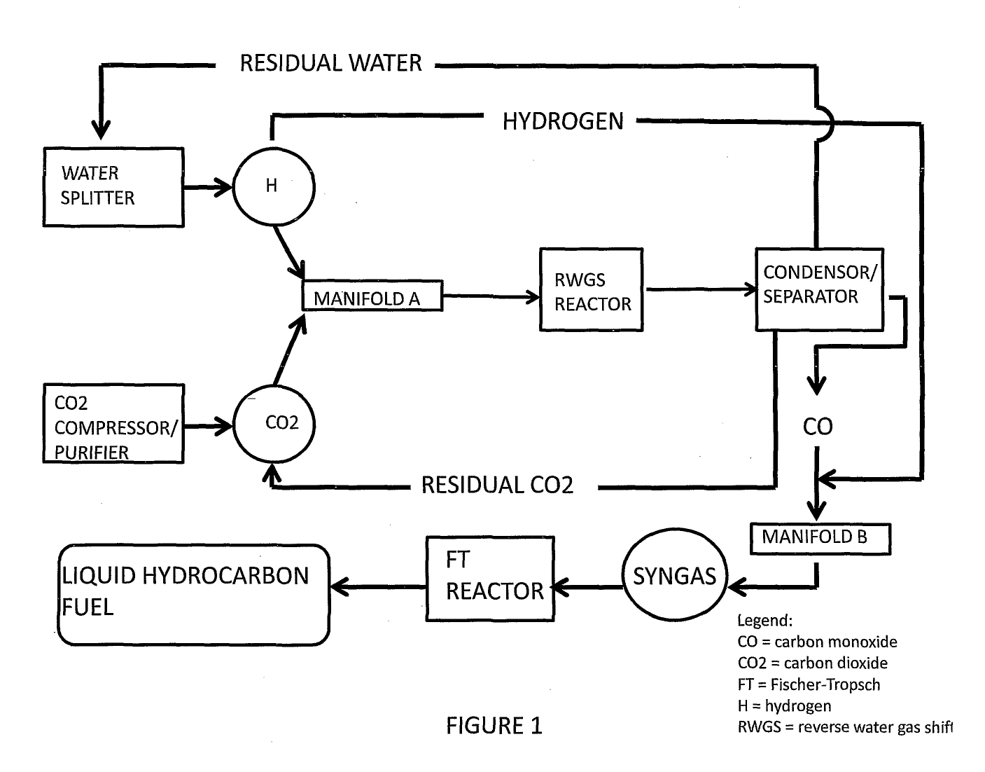

Referring to FIG. 1, the invention 10 is a system for producing synthetic hydrocarbon fuels, comprising a unit containing hydrogen gas 12 and a unit containing carbon dioxide gas 14. The hydrogen gas 12 may come from a water splitter 16. The carbon dioxide gas 15 may come from a carbon dioxide compressor/purifier 18. The hydrogen is transferred 20 to a manifold 22 indicated as ‘Manifold A’ in FIG. 1. The manifold 22 is comprised of two lateral inlet pipes one 24 of which conveys the hydrogen gas 12 and the other 26 of which conveys the carbon dioxide gas 14. The manifold 22 transfers gases to a RWGS reactor 30 in which the gases undergo a Reverse Water Gas Shift reaction. Next, the reacted gases enter a condenser/separator unit 32 which separates CO gas 34, residual water 36 and CO2 38. The CO gas 34 is sent 42 towards a second manifold 44 identified in FIG. 1 as ‘Manifold B’. The hydrogen gas is added 42 from the hydrogen gas source 12 just prior to manifold B 44. The CO2 gas 38 is returned to the CO2 gas source 14. Residual water 36 is sent back to the water splitter 16 for further splitting.

Manifold B 44 comprises two inlet pipes. The first inlet pipe 46 conveys the CO gas 34 and the second 48 conveys hydrogen gas from the hydrogen gas source 12. Manifold B 44 transfers the gasses to a mixing unit 50 wherein the hydrogen gas and CO gas are mixed to form synthesis gas (a.k.a. syngas, a mixture of hydrogen and carbon monoxide). The syngas is transferred 52 to a Fischer Tropsch reactor 54 wherein the syngas is converted into a liquid hydrocarbon fluid 56.

In one embodiment of the invention the hydrogen production unit 16 is based on water splitting by means of a photo-chemical process.

In another embodiment of the invention the hydrogen production unit 16 is based on an electrolysis process.

In yet another embodiment of the invention the hydrogen production unit 16 is based on a thermal-electrolysis process.

In one embodiment of the invention the hydrogen production unit 16 is based on a thermal-chemical process.

Other embodiments of the invention may include combinations of the aforementioned hydrogen production processes.

In a preferred embodiment of the invention the level of purity of the carbon dioxide (CO2) 15 exceeds that of raw power plant exhaust captured in an initial pass from a stationary combustion engine.

In a preferred embodiment of the invention the reverse water gas shift reactor 30 is optimized for carbon monoxide production.

Downstream from the condenser/separator 32 separately-fed hydrogen 42 and CO gases 34 are mixed according to predetermined H/CO mole ratios. The mole rations are

adjustable.

In one embodiment of the invention the Fischer-Tropsch reactor 54 is of a type that processes syngas whose composition is defined by the mole ratios described above.

The invention describes a process for producing synthetic hydrocarbon fuels, comprising the following steps:

(a) providing a unit containing hydrogen gas;

(b) providing a unit containing carbon dioxide gas;

(c) providing a manifold (‘Manifold A’) comprised of two lateral inlet pipes, one of which

conveys the hydrogen, the other of which conveys the carbon dioxide;

(d) providing a RWGS reactor;

(e) reacting the contents of the manifold in a Reverse Water Gas Shift reaction within the RWGS reactor;

(f) providing a condenser/separator unit;

(g) separating CO from residual water, CO2, and hydrogen in the condenser/separator unit;

(h) providing a manifold (‘Manifold B’) comprised of two inlet pipes, one of which conveys the CO from the condenser/separator unit and the other of which conveys the hydrogen from the hydrogen source;

1. (I) providing a mixing unit into which contents of Manifold B are mixed to form synthesis gas (a.k.a. syngas, a mixture of hydrogen and carbon monoxide);

(j) providing at least one Fischer Tropsch synthesis unit in communications with the syngas mixer to convert syngas to liquid hydrocarbon fuels.

In the described process the step of providing hydrogen gas may comprise the step of producing hydrogen by one of the following methods of splitting water: (i) a photo-chemical process; or

(ii) an electrolysis process; (iii) a thermal-electrolysis process; (iv) a thermal-chemical process; or (v) any combination thereof. The level of purity of said carbon dioxide (CO2) used in the process exceeds that of raw power plant exhaust captured in an initial pass from a stationary combustion engine. The reverse water gas shift reactor is optimized for carbon monoxide production. Residual CO2, water, and hydrogen are returned to their respective initial sources within the described system. The separately-fed hydrogen and CO gas are mixed in the syngas mixing unit according to predetermined H/CO mole ratios and wherein said mole ratios are adjustable. The Fischer-Tropsch reactor is of a type that processes syngas whose composition is defined by the mole ratios described above.

1. A system for producing synthetic hydrocarbon fuels, comprising:
(a) a unit containing hydrogen gas;
(b) a unit containing carbon dioxide gas;
(c) a manifold (‘Manifold A’) comprised of two lateral inlet pipes, one of which conveys said hydrogen, the other of which conveys said carbon dioxide;
(d) a unit into which contents of said manifold enter and undergo a Reverse Water Gas Shift reaction;
(e) a condenser/separator unit which separates produced CO from residual water, CO2, and hydrogen;
(f) a manifold (‘Manifold B’) comprised of two inlet pipes, one of which conveys the CO from step ‘e’ and the other of which conveys the hydrogen from step ‘a’;
(g) a unit into which contents of manifold pipe in step ‘f’ enter and are mixed to form synthesis gas (a.k.a. syngas, a mixture of hydrogen and carbon monoxide);
(h) one or more Fischer Tropsch synthesis units which convert syngas to liquid hydrocarbon fuels.

2. The system of claim 1 (a), wherein said hydrogen production unit is based on water splitting by means of:
(i) a photo-chemical process; or
(ii) an electrolysis process; or
(iii) a thermal-electrolysis process; or
(iv) a thermal-chemical process; or
(v) any combination thereof.

3. The system of claim 1 (b), wherein the level of purity of said carbon dioxide (CO2) exceeds that of raw power plant exhaust captured in an initial pass from a stationary combustion engine.

4. The system of claim 1 (d), wherein the reverse water gas shift reactor is optimized for carbon monoxide production.

5. The system of claim 1 (e), wherein residual CO2, water, and hydrogen are returned to their respective initial sources within the described system.

6. The system of claim 1 (g), wherein said separately-fed hydrogen and CO gas are mixed according to predetermined H/CO mole ratios and wherein said mole ratios are adjustable.

7. The system of claim 1 (h), wherein said Fischer-Tropsch reactor is of a type that processes syngas whose composition is defined by the mole ratios described in claim 6.

8. A process for producing synthetic hydrocarbon fuels, comprising:
(a) a unit containing hydrogen gas;
(b) a unit containing carbon dioxide gas;
(c) a manifold (‘Manifold A’) comprised of two lateral inlet pipes, one of which conveys said hydrogen, the other of which conveys said carbon dioxide;
(d) a unit into which contents of said manifold enter and undergo a Reverse Water Gas Shift reaction;
(e) a condenser/separator unit which separates produced CO from residual water, CO2, and hydrogen;
(f) a manifold (‘Manifold B’) comprised of two inlet pipes, one of which conveys the CO from step ‘e’ and the other of which conveys the hydrogen from step ‘a’;
(g) a unit into which contents of manifold pipe in step ‘f’ enter and are mixed to form synthesis gas (a.k.a. syngas, a mixture of hydrogen and carbon monoxide);
(h) one or more Fischer Tropsch synthesis units which convert syngas to liquid hydrocarbon fuels.

9. The process of claim 8 (a), wherein said hydrogen production unit is based on water splitting by means of:
(i) a photo-chemical process; or
(ii) an electrolysis process; or
(iii) a thermal-electrolysis process; or
(iv) a thermal-chemical process; or
(v) any combination thereof.

10. The process of claim 8 (b), wherein the level of purity of said carbon dioxide (CO2) exceeds that of raw power plant exhaust captured in an initial pass from a stationary combustion engine.

11. The process of claim 8 (d), wherein the reverse water gas shift reactor is optimized for carbon monoxide production.

12. The process of claim 8 (e), wherein residual CO2, water, and hydrogen are returned to their respective initial sources within the described system.

13. The process of claim 8 (g), wherein said separately-fed hydrogen and CO gas are mixed according to predetermined H/CO mole ratios and wherein said mole ratios are adjustable.

14. The process of claim 8 (h), wherein said Fischer-Tropsch reactor is of a type that processes syngas whose composition is defined by the mole ratios described in claim 6.
